(19) United States
(12) Patent Application Publication
(10) Pub. No.: US 2014/0030679 A1
(43) Pub. Date: Jan. 30, 2014

(54) ART TEACHING SYSTEM AND RELATED METHODS

(71) Applicant: Kwok Chun Wong, Hong Kong (CN)

(72) Inventor: Kwok Chun Wong, Hong Kong (CN)

(21) Appl. No.: 13/261,560

(22) PCT Filed: Apr. 18, 2011
(86) PCT No.: PCT/IB2011/000942

§ 371 Date: Jan. 8, 2013

(51) Int. Cl. G09B 11/00

(52) U.S. Cl. CPC G09B 11/00
USPC 434/88

(57) ABSTRACT

An interactive education system for teaching and practicing art and associated methodology. The objective of the system is two-fold. First, the system displays distortion-free demonstrable or traceable images, both still and motion, onto a student's working paper on a study desk. The system can demonstrate the proper writing sequence to achieve a certain art and illustrate the path and speed of a stroke. In the preferred embodiment, the system uses a projector which is configured in a way to prevent the formation of a shadow due to student's hand during writing. The method for the system involves determining the potential shadow from the user and recommending a location of one or more projectors accordingly. The second objective of the system is to provide quantitative feedback to the student. To this end, the system can evaluate the student's work by comparing it to an original, benchmarked image.

### TECHNICAL FIELD

The present invention relates to a system for teaching art and associated methodology. More specifically, the system aspect of the present invention involves using one or more projectors, one or more cameras, a computer, and software to display demonstrable or traceable images—both still and motion—onto a student's working paper on a study desk, wherein: 1) the system can prevent the formation of a shadow due to the palm or the fingers during writing; 2) the system can demonstrate how to produce art in real time by displaying different colors or according to different brush speeds and strokes; 3) the projector can be placed at any reasonable distance and angle from the study desk to accommodate all users and any art style; 4) the camera can capture an image from the working paper; 5) the software can judge the accuracy of the character or drawing to provide quantitative feedback of the student's efforts; and 6) the software can fine-tune the shape of all images to correct any distortion due to the variably relative positions of the projector and camera from the working paper.

### BACKGROUND ART

Learning Chinese art is a cultural tradition. Students of Chinese art often start from “lin” and “mo.” Literally, the Chinese character “lin” ( [symbol] ) means “to get near,” or “to view from a height.” In Chinese art, however, lin is described as “imitating and copying a classic piece of artwork by placing it on one side.” Similarly, Chinese art defines “mo” ( [symbol] or [symbol] ) as “producing an exact copy from a model artwork.” Often, this is done by a technique called “shadow tracing” ( [symbol] ); i.e. placing a semi-translucent paper on top of the original art work and then outlining and/or tracing the piece to produce an exact copy. The purpose of the lin and mo process is to learn the methods used in model artworks by grand masters recognized in the history of Chinese art, i.e., the classical basics. Knowledge of these basics usually precludes any attempt to create one's own original Chinese artwork.

Nevertheless, some problems exist with the lin and mo process. To lin, i.e. place the model piece of artwork on one side, is extremely difficult for a beginning artist because he or she has to judge, by naked eye, the sizes and relative positions of the various brush strokes. This can be remedied by drawing standard gridlines on both the model artwork and the working paper. But, gridlines have limitations. First, the gridlines cannot show or teach the sequence to produce an image. Without knowledge of the proper sequence, learning to write certain images is extremely difficult. Another limitation is caused by the nature of commonly used gridlines. Unless the gridlines are in close proximity to one another, the gridlines are not helpful. This is because the student has to turn his head many times—first turn to the left to read the sizes and relative positions of the strokes on the model art work with respect to the gridlines, temporarily memorize the stokes, and then turn back to the center of the table to order to write on the blank paper with gridlines accordingly. This head turning process is repeated many times before a single character is finished.

In the ‘lin’ process, other problems in using gridlines can be elaborated by considering the regular script ( [symbol] ) of Chinese calligraphy as an example. Traditionally, regular script Chinese characters are written within drawn squares. These square confine the size of each character to be written, thus providing a neat and consistent look for the entire passage. However, for beginning students who have not yet mastered the lin process, a plain square is an insufficient learning tool for at least two reasons. First, the beginner must imitate the original artwork, stroke by stroke. Yet, it is difficult to ascertain the size and relative position of each brush stroke of the Chinese character. Second, this first issue is complicated by the fact that the student also must simultaneously attempt to write the character within the square's center. It is therefore essential for beginners to draw further supporting gridlines subdividing the perimeter square. Numerous methods exist to subdivide the perimeter square, including: 1) the traditional 3×3 magic square ( [symbol] ) as shown in Fig. (a); 2) a single cross inside the square ( [symbol] ) as shown in Fig. (b); and, 3) double crosses inside the square ( [symbol] ) as shown in Fig. (c).

There is no consensus on which method of subdivision performs best. Thus, the student may select the method which he finds most useful in learning (i.e. learning the classical basics, that is, judging sizes and positions of the brush strokes and/or centering the character in the perimeter square).

Unfortunately, using gridline subdivisions is a clumsy process. The student must draw the perimeter square and the desirable subdivisions onto the image to be copied. Typically, the image to be copied is a reproduced image printed inside a book made for learning purposes. In principle, the student may draw the desired gridline pattern directly onto the book. Yet, that would damage the book. Moreover, the way learning books often display images further complicates the gridline subdivision process. Some books utilize reproduced images containing gridlines printed over the image. Other books display inverted images—where the image to be drawn is white, while the background is black, as shown in Fig. (d). In both of these instances, beginners find it difficult to distinguish the gridlines from the paper, even when the gridlines are white. Still other books display reproduced images in red or gray tones or as an outline. Such books allow the student to practice the mo tracing exercise. Fig. (e) shows a gray toned reproduced image.

Even with the help of exercise books, the student may still encounter problems. First, exercise books provide only a limited number of grids. Second, the scale of the image in the book may not be suitable for the student's practice, that is, the student may wish to train by writing bigger or smaller characters than those provided in the book. Third, often book's image is unclear and/or unauthentic because it was a product of multiple reproductions of an original image. Fourth, many images typically are not reproduced directly in exercise book form. Finally, exercise books are often printed using ordinary paper unsuitable for calligraphy. Such books typically use book paper instead of Xuan paper ( [symbol] or rice paper), which is soft- and fine-textured and generally agreed to be the most suitable paper for conveying the artistic expression of Chinese calligraphy and painting. But, machines cannot easily print and bind rice papers into exercise books because of its physical properties.

Remedies addressing the shortcomings of gridlines are available. Such options include: photocopying the best image available using a desirable scale (usually a scale closer to the original calligraphy) and reverting that image back to a positive image if the photocopying machine allows; drawing the type of gridlines accustomed to the student (3×3 magic square, single or double crosses . . . etc.) onto this positive image; and drawing the same set of gridlines onto the rice paper for repeated ‘lin’ practices or using rice paper with pre-printed gridlines.

However, these remedies are time-consuming and cannot completely extinguish the problems associated with physical gridlines. Moreover, they also create new issues. Drawing gridlines on both the photocopied image and on rice paper often takes longer than the calligraphy practice itself. Rice papers with gridlines pre-printed are inflexible—the size and type of grids cannot be changed unless one buys another set of grid-lined rice papers and draws over the pre-printed lines. Most importantly, gridlines do not allow the student the satisfaction of a complete piece of artwork. The student's final work will still contain gridlines.

Unlike the lin process, the mo (tracing) exercise does not require gridlines. Yet, it has its own complications. During mo, the original artwork is traditionally placed under rice paper. However, the rice paper's thickness makes it less translucent, thus rendering the original artwork visually unclear. Using a more translucent paper creates additional issues: such paper is typically less absorbent. Should the ink bleed through the paper, the mo process may risk damaging the original art work. This could be remedied by using a photocopy instead of the original art work. But, if the ink bleeds, the photocopy cannot be re-used for further practice.

Problems associated with the mo process are usually addressed by printing the original black positive image in an exercise book in a red or gray tone or as an outlined image. This allows the student to trace each stroke using black ink. But, one cannot possibly photocopy a red, gray, or outlined image onto rice paper for his ‘mo’ exercise repeatedly. One reason is that producing an exact of the original image onto rice paper is a difficult and costly task—one usually handled only by professional printing houses. Another reason is that rice paper is too soft, and the sizes are usually not standardized (usually much too large) to be placed into the paper tray of a photocopying machine. For these reason, mo is a less popular method of training.

The sequence limitation problem arises from using lin or mo for teaching certain Chinese art. One example is called cursive script. Cursive script ( [symbol] ) is a form of Chinese art that involves one very long and complicated brush stroke, where the Chinese characters are written continuously from one character to another and each character is no longer confined by standard squares. It is virtually impossible for a new learner to attempt the cursive script ( [symbol] ) by using either lin or mo because of this brush stroke. This sequence learning complication also arises in most forms of art or writing that require more than simple strokes. Drawing standard gridlines on these continuous strokes may not make much sense, as (a) characters are generally not confined to lengths and widths of a square; and (b) it is not only the relative positions of strokes, but the flow of the brush strokes in the overall passage, that matters. If the image of the whole passage is printed on one page of common-size book, then it may be too small to be studied clearly. If the image of the whole passage is broken down and printed into separate pages, the student may not be able to see and practice the flow for the entire passage. Moreover, it would be costly to print multiple copies of the passage on rice paper for repeated mo exercises.

Generally, while writing Chinese art, the length, direction, and angle of the pen for each stroke must be taken into account. Though these considerations can be taught by an experienced Chinese art teacher, it is important to note that such teachers are often rare and expensive. Although alternative calligraphy learning options (such as Wikipedia, findyourinnercalligrapher.com, and Calligraphy for Dummies) are available to help individuals understand the style, these options cannot account for the many issues that result from learning common scripts such as seal script ( [symbol] ), clerical script ( [symbol] ), regular script ( [symbol] or [symbol] ) running script ( [symbol] ), or cursive script ( [symbol] ).

Such problems include, but are not limited to, the following categories: 1) basic methods in using the brush ( [symbol] ); 2) the structures of the characters, and hence the positioning of the strokes ( [symbol] ); 3) seals and the layout of the whole artwork ( [symbol] ); and, 4) artistic expressions ( [symbol] ).

The present invention addresses the need for assisting a beginner student in Chinese art in judging the sizes, relative positions, and sequences of various brush strokes without drawing gridlines; the need for clearly reproducing Chinese artwork for learning purposes without damaging the original artwork or prints; and the need for additional options for learning the basic principles of Chinese art in an economic, material efficient, and timely manner.

### DISCLOSURE OF INVENTION

The present invention involves a novel system for teaching art and associated methodology. According to an aspect of the present invention, the system uses a computer containing with one or more projectors and distortion correction software to display demonstrable or traceable images, both still and motion, onto a student's working paper on a study desk. In general, the system is able to demonstrate the proper sequence to achieve a certain artwork. For still images, two-tone projections will suffice. With regards to displaying images in motion, the projections will be in different color tones, color shades, or utilize other ways to illustrate the path and speed of a stroke.

According to an aspect of the invention, one or more projector is configured near a user's workspace in a way to prevent the formation of a shadow due to user's hand during writing. The projectors can be placed at any reasonable distance and any angle from the study desk to minimize the shadow of any user and any artwork. Further, the software is able to fine tune the shape of all images and correct any distortion due to the variably relative position of the projectors and camera from the working paper.

According to an aspect of the present invention, one or more cameras are used to capture an image from the students working paper. Once the captured imaged is processed, the software can analyze the geometrical structure the work-product by comparing it to the original image. In essence, the software will determine the aesthetics of the art by using benchmarked parameters of the original artwork. By continuously comparing the images, the system is able to provide quantitative feedback of the authenticity of the student's efforts both in real time and in a cumulative aspect.

The manner of projecting images (including gridlines) in any desirable scale onto the working surface offers a host of additional features unavailable via the traditional ways of teaching students other than from a master. It offers students a chance to repeat the exercises without the pitfalls involved with setting up working paper and gridlines. It also offers these enhanced repetitions on proper working paper. It offers increased time efficiency because the system automatically creates the proper gridlines for the student. It offers the student the opportunity to scale the image to any desirable size. It advantageously separates the original artwork from potential ink stains. Finally, it removes gridline traces from the student's physical artwork, thereby allowing the student to fully complete a piece of artwork even during practice.

### BRIEF DESCRIPTION OF DRAWINGS

FIG. 1 is a perspective view of an art teaching system for a right-handed student including a projector, a camera, and a desk with working paper displaying an image after distortion correction according to an aspect of the invention;

FIG. 2 is a three axis graph that shows the placement limitations of the camera with respect to the center of the working piece;

FIG. 3 is a perspective view of an art teaching system for a left-handed student including a projector, a camera, a monitor, and a desk with working paper displaying an image before and after distortion correction according to an aspect of the invention,

FIG. 4 is a flow chart describing the method steps involved in the system of teaching art according to an aspect of the present invention.

FIG. 5 is a perspective view of an art teaching system for a left or right-handed student including a two projectors, two cameras, a monitor, and a desk with working paper displaying an image before and after distortion correction according to an aspect of the invention;

### BEST MODE FOR CARRYING OUT THE INVENTION

Illustrative embodiments of the invention are described below. In the interest of clarity, not all features of an actual implementation are described in this specification. It will, of course, be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. The system for teaching Chinese art, components for such system, software for such system, and associated methodology disclosed herein boasts a variety of inventive features and components that warrant patent protection, both individually and in combination.

FIG. 1 is a perspective view of a system for teaching Chinese art including a projector 10, a camera 20, a working piece 30, a working table 40, a stand 50, and a computer 60. The projector 10 and the camera 20 are hung on the top of a stand 50. Both the camera 20 and projector 10, by way of example only, are electrically connected to the computer 60. The computer 60 has the capabilities of coordinating all the works of the projector 10 and the camera 20. The projector 10 is displaying character 70 on the working piece 30. The camera 20 is scanning both the student's actual work product as he or she writes on the working piece 30 and the character 70 displayed by the projector 10. In general, the system is able to distinguish between the work product of the student and any image displayed by the projector 10. The system is also able to determine whether and exactly where a shadow is formed. The stand 50 is portable, and placed on the ground by the side of the working table 40. By way of example only, the stand 50 is placed on the left side of the user because the type of art being practiced in the example.

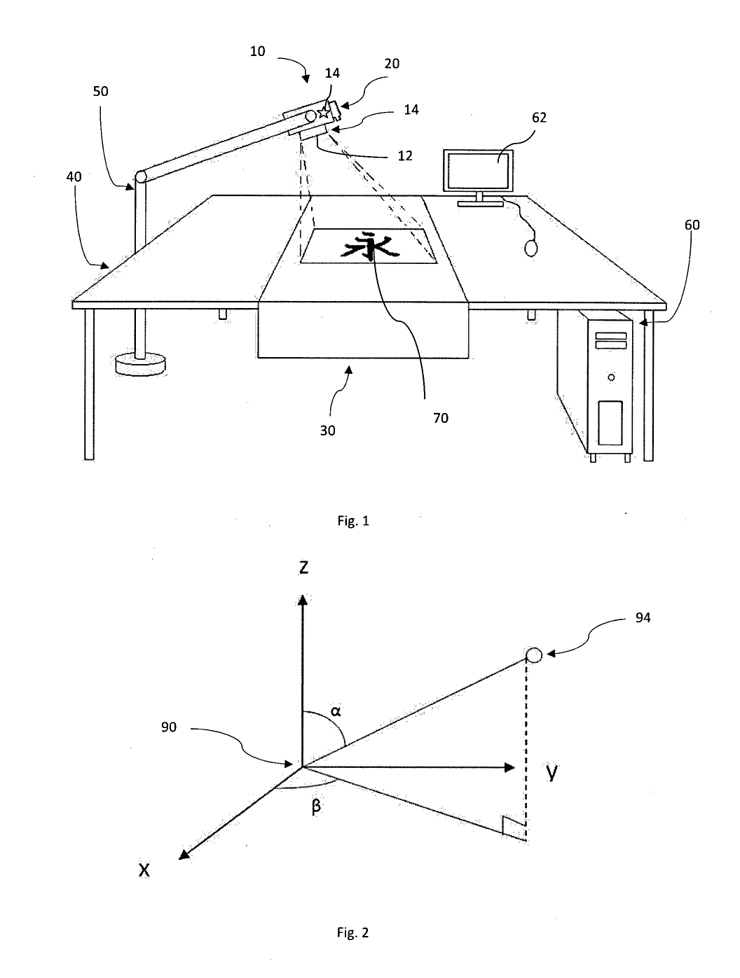

Now referring to FIG. 2, to prevent the formation of a shadow caused by the palm or the fingers during writing, the projector 10 must be placed at an angle, α, up to 45° from the vertical and any angle, β, horizontally. The center of the working piece is located at the origin 90, and the angles β and α define the camera location 94. Angle α lies in the z-y plane when the camera location 94 is located directly under the y axis. Angle β lies in the x-y plane.

Referring back to FIG. 1, under such condition, the character 70 (without distortion correction) displayed on the working paper would be highly distorted. By way of example only, the projector 10 is tilted in a position 15° from vertical and 25° from horizontal, and is located 2 meters from the working piece 30. Although shown in this precise position, the stand 50, projector 10, and camera 20 combination may be configured and arranged around the user in any number of suitable manners and structures sufficient to display a given piece of artwork for a given user. It is also contemplated to construct a system that uses multiple projectors and multiple cameras to accommodate certain types of artwork. Moreover, although shown in a unitary fashion, the projector 10 and the camera 20 may be constructed as separate components without departing from the scope of the invention.

While there is no maximum or minimum distance that the projector 10 can be from the working piece 30, the recommended range for this embodiment is one to three meters. The uppermost range, however, greatly depends on the quality of the projector and the brightness of the lamps in the projector. A higher quality projector would have the capability of properly displaying distortion-free images greater than three meters from a working piece. As discussed below, the computer 60 contains software that will correct what would be a distorted image due to the tilt of the projector 10. The software also has the capabilities of projecting images and/or gridlines in any desirable scale.

In either event, the projector 10 contains a lens 12 located at the distal end of the slide 14. The lens 12, manually adjustable, is used for focusing purposes to provide a sharp image, still or in motion, on the working piece 30. The mechanics and operation of this exemplary projector 10 and lens 12 will be described in greater detail below.

By way of example only, the projector 10 displays a black and white still image. But, the projector 10 can also display gray and color-toned images, still or in motion. To learn the technique of brush strokes, the user watches a video clip on the computer monitor 62 showing the sequence of brush strokes. However, the software also can display the video clip (by way of the projector 10) directly onto the working piece 30 alongside the still image of the character 70. It is convenient if the user selects this option because he or she does not have to look at the monitor. Further, by displaying the video clip directly onto the writing paper, the user can easily trace the brush strokes of the teacher or the demonstrator and then write directly on the still projected image of the character 70. This provides for a major benefit—the student can create a final copy of the art during practice without gridlines.

Having described, in detail, the specifics of one type of system according to an aspect of the present invention, a variety of additional systems forming aspects of the present invention will now be described. Based on many of the common features and/or functionality with the system described above, the following description and the associated drawings will not include specific references to associated systems or much (if any) added detail regarding the associated methodology (which will be described later), as such is deemed duplicative and unnecessary.

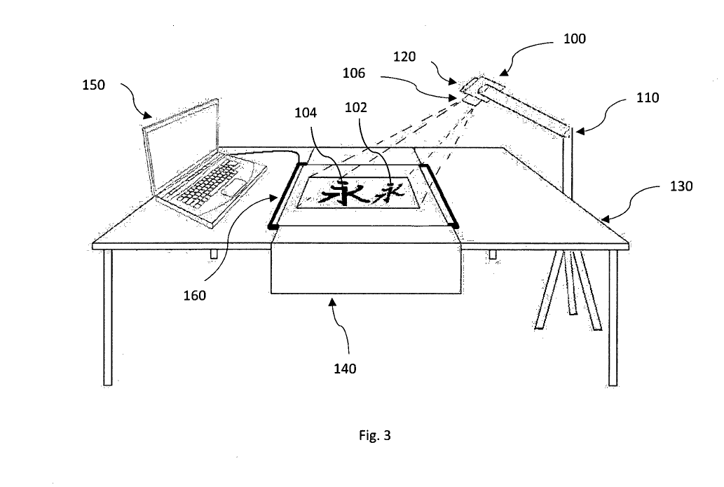

FIG. 3 is a perspective view of a system for teaching Chinese art including a projector 100, a stand 110, a camera 120, a working table 130, a working piece 140, a computer 150, and a monitor 160. The stand 110, the projector 100, and the camera 120 are located on the opposite side of the working table 130 as the corresponding components shown in FIG. 1. This movable capability presents a host of benefits. One benefit is convenience. The mobility of the projector allows the system to be used in nearly any physical setting. Second, and more importantly, the system setup is dynamic in nature, thereby allowing all types of images to be displayed without a shadow. This solves the problem created by the varying optimal projector 100 tilt angle for a given piece of artwork—as discussed above. In general, a piece of art that requires the writer to place his hand closer to the working piece 140 requires a greater angle of tilt in the horizontal plane (as shown in FIG. 2) than for a piece where the hand is further away from the working piece 140.

FIG. 3 shows character 102, which is the distorted form of character 104. By way of example only, the distortion correction takes two forms. First, the lens 106 on the projector 100 can be manually adjusted to slightly correct the distortion. Second, the software will impose an affine transformation on the image (both still and motion) to pre-distort it before the image is sent to the projector 100. By way of example only, several geometric parameters must be adjusted by using the “right”, “left”, “up”, “down”, and “shift” keys on the keyboard of the personal computer. Such pre-distorted images (shown as character 102) will become regular (shown as character 104) once projected on the paper. In the interest of clarity, the two forms of distortion control used in this embodiment are not exclusive to the present invention. The distortion correction can take any number of forms according to an aspect of the invention.

Still referring to FIG. 3, the monitor 160 is placed underneath the working piece 140, allowing images and gridlines to be visible on the side of the paper facing the user. The images created by the monitor 160 also assist in distortion correction. By providing an entirely undistorted image, the monitor 160 serves as a benchmarked image for distortion correction, that is, the camera 120 can use the scanned monitor image instead of the downloaded image. But, the monitor 160 has other purposes. Not only can the monitor 160 display images on the working piece 140, the monitor 160 can also scan the image created by the user—a function also performed by the camera 120. In essence, the monitor 160 works in tandem with the camera 120 to provide the scanning function of the system. In this embodiment (by way of example only), the monitor 160 and camera 120 serve as a check for one another. It is also contemplated that the monitor 160 and camera 120 could serve different scanning functions. Specifically, the monitor 160 could be used to scan the user's work while the camera could be used to scan the image produced by the projector 100. In the interest of clarity, while the monitor 160 is used together with the projector 100, it also could be used as an alternative to the projector 100.

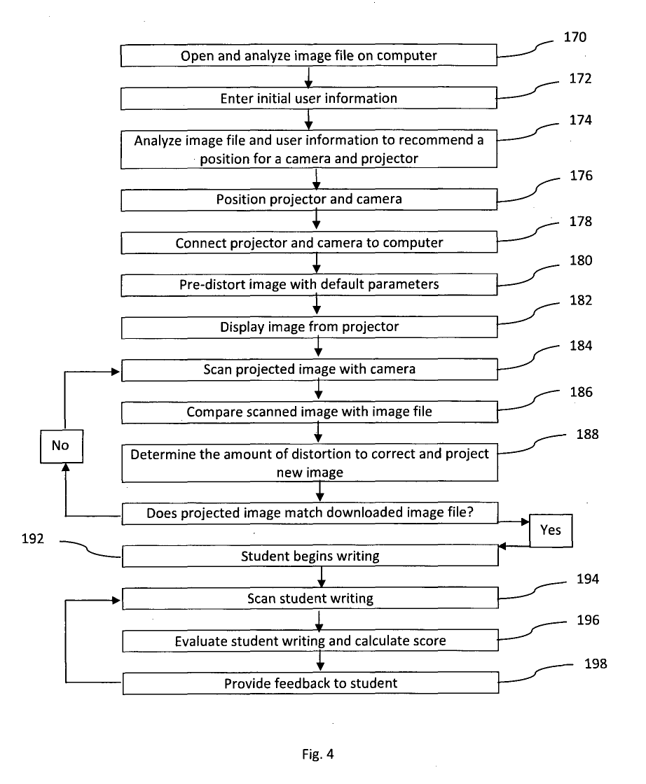

The methodology associated with the software used to display undistorted still and motion images according to an aspect of the present invention will now be described with reference to FIG. 1, as well as the flow chart in FIG. 4. The first four steps involve the initial set-up phase (steps 170-176 in FIG. 4). The first two steps in the initial set-up phase do not require any particular order. In these two steps, the user opens an image file on the computer 60, and the software analyzes the image file (step 170 in FIG. 4). The user then enters the initial user information (step 172 in FIG. 4). For example, and as discussed below, the user information may include the hand the user will be writing with, the user's skill level, the table height and shape, and the type of signature to model.

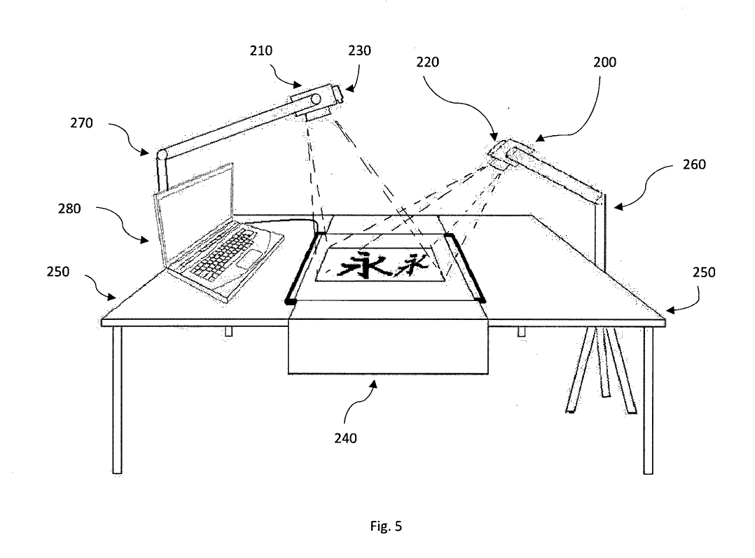

In the next step, the software evaluates both the image file and the user's information to recommend a placement position for stand 50 (containing the projector 10 and camera 20) to minimize the shadow created by the user's hand and fingers (step 174 in FIG. 5). The software utilizes a number of variables including, but not limited to, initial user information (as entered in step 172), the shape of the artwork, the type and number of stokes required by the artwork, the number and sizes of images to be copied, and the positions of the images relative to the projector.

Still referring to step 174, the software considers potential blind spots for the camera. As such, the software would not recommend a position for the stand 50 if the camera 20 is totally blocked by the user—even if no shadow would form. By way of example only, the software in this embodiment determines the optimal location for the stand 50, projector 10, and camera 20 as a whole. The system instructs the user to position the locator tab 14 (as shown in FIG. 1) based on a radial distance away from the center of the working piece 30 and based on a vertical height from the ground. Once the tab is in position, the system instructs the user to tilt the projector 10 and camera 20 to complete the set-up phase. The user then positions the projector 10 and camera 20 (step 176 in FIG. 5) according to the software recommendation, and connects the projector 10 and camera 20 to the computer 60 (step 178 in FIG. 5).

While located in the same position in the embodiment of FIG. 1, it is contemplated that camera 20 and projector 10 can be located in different positions. Having camera 20 and projector 10 in different positions would allow the projector 10 to be located in a location that minimizes the potential shadow without considering whether the camera 20 is blocked. Likewise, the camera 20 can be positioned in a location that minimizes the potential blind spots. That said, the system would recommend the camera 20 and projector 10 positions independently. Although shown and described mounted to stand 50, the camera 20 and/or projector 10 can be mounted anywhere using any means. Depending on the atmosphere and if desired, the camera and/or projector could, for example, be mounted to a wall or the ceiling, placed underneath a transparent table, located inside a computer, or even suspended by a cable.

With the initial set-up phase complete (steps 170-176 in FIG. 4), the next step of steps involves correcting distortion. For the first step in correcting distortion, the software will pre-distort the image file with default parameters (step 180), and display the image from the projector 10 (step 182 in FIG. 4). The default parameters are based on the position of the projector 10 to the working piece 30 as well as other variables. In the next step, the camera 20 scans the semi-distorted image (step 184 in FIG. 4). With the goal of creating an undistorted image (character 70 as shown in FIG. 1), the software compares the semi-distorted image captured by the camera 20 as shown in FIG. 1 (or, alternatively, the monitor 160 in FIG. 3) with the benchmarked parameters from the image file (step 186 in FIG. 4). The next step is to determine the extent of distortion correction needed and project a new image (step 188 in FIG. 4). With the new image projected, the distortion correction series of steps restarts and continues indefinitely until the projected image sufficiently matches the benchmarked parameters from the image file to a precision mandated by the software or user. It is contemplated that the software could use any number of feedback algorithms to perform the distortion correction.

Once the displayed image is distortion free, the student begins writing. As the student writes on the working paper 30, the camera 20 (or, alternatively, the monitor 160 in FIG. 3) scans the student's writing (step 194 in FIG. 4). The software then evaluates the student's writing by comparing it to the benchmarked parameters based on the image file and calculates a quantitative score for the quality of the work (step 196 in FIG. 4). In the last step, the system provides this quantitative feedback to the student (step 198 in FIG. 4).

The system provides both dynamic and static feedback to the student. The dynamic feedback is provided continuously throughout the writing process, allowing the student to distinguish between where he or she has difficulties and where he or she writes properly. Upon completion of a piece of work, static feedback of the overall work is provided to the student based on a number of variables including, but not limited to, the shape of each individual image, the skew of each individual image, components of individual images, and the relationship between each of the individual images (relative to the position and skew).

The software also considers the nature of the writing when providing feedback. In calligraphy, for example, although everybody writes characters in limited styles, different calligraphers could depict the same character differently. This phenomenon refers to the signature of the writer for that particular character. New learners try their best to adhere to the signature of famous calligraphers, i.e. virtual masters, through lin and mo.

According to an aspect of the present invention, techniques of artificial intelligence are incorporated to recognize signatures. To that end, the signature of characters of selected virtual masters is recorded and analyzed using artificial neural networks. By way of example only, up to six variables, fed into a neural network, can represent each character. The software utilizes back propagation to train the neural network. This allows the neural network to adapt to characters written by every selected virtual master. Once the user writes a character, the system scans the image and feeds it to the computer. This back propagation feature could extract the six variables out from the image and feed them into the neural network. If the user's written character 100% matches the same character written by the virtual master, a 100% score will be returned. Otherwise, a resemblance score will indicate how closed the user's character is to that of the virtual master.

FIG. 5 is a perspective view of an interactive system for teaching art including a first projector 200, a secondary projector 210, a first camera 220, a second camera 230, a working piece 240, a working table 250, a first stand 260, a second stand 270, and a computer 280. The first stand 260 is a tripod stand and the second stand 270 is mounted to the working table 250. All other features in common with the systems of FIGS. 1 and 3 are denoted with the same reference numbers and an explanation of then functionality may be ascertained with reference to the discussion of those similar features with reference to FIGS. 1 and 3.

The system of FIG. 5 presents an example embodiment that demonstrates yet another method of minimizing a shadow created during writing. By way of example only, two projectors (first projector 200 and secondary projector 210) handle the shadow minimization. In this scenario, the second projector 220 illuminates the shaded area of the working piece 240. However, to facilitate this embodiment, the system set-up requires more advice from the software. Specifically, the software must recommend a position for the first projector 200 that may not minimize the shadow by itself. Nevertheless, in combination with the secondary projector 210, the overall positioning of the first projector 200 and the secondary projector 210 would, in fact, minimize the potential shadow. Without software recommendation, a student likely would not optimize the potential of using two projectors.

To set up the system, the student first opens the image file and enters the initial user information (as discussed above). The software analyzes the image and initial user information to recommend a position for the first projector 200 and for the first camera 220. Next, the system provides a test pattern onto the working piece 240 by way of the first projector 200 and captures the test pattern by way of the first camera 220. The system then analyzes the test pattern and provides calibration data. The calibration data is used correct the current distortion.

According to an aspect of the present invention, the system then determines whether and where a shadow would likely form based on the user's hand strokes (which were determined when the software analyzed the image). The system next recommends a placement position for the secondary projector to eliminate the potential shadow. Similarly, the system determines whether and where the camera will witness a blind spot based on the user's hand strokes and recommends a placement position for the secondary camera to eliminate the potential blind spot. By providing the two projectors in this way, the student will have a shadow-free display of an image. By providing the two cameras in this way, the feedback to the student will not be interrupted.

The system in FIG. 5 offers another feature. In this embodiment, the student can select a size and location for the image or images to be displayed. In most instances, the student will choose to maximize the size of the image or images relative to the working piece 240. The system can maximize one or more images onto the working piece 240 without any user input. To this end, the system calculates the length and width of the working piece 240. However, the student can also manually input the size of the paper. This action serves to accommodate for a working piece 240 (as shown in FIG. 5) longer than the working table 250 which the cameras 220 and 230 could not properly size.

But, this image placement feature is not limited to maximizing the images on the working piece 240 according to an aspect of the invention. For example, the student may also decrease the size of one or more images to allow for more images to be constructed onto the working piece 240. Although described in these two specific manners, the system can provide a variety of recommendations to the user.

Having described a multitude of the aspects of the present invention, including aspects of the system and associated methodology, it should be understood that this invention is not limited to only those aspects described above and that changes and modifications may be made without departing from the true spirit and scope of the invention as defined in the appended claims.

What is claimed is:

1. An interactive education system for teaching and practicing art, the system comprising:
one or more image display devices displaying one or more demonstrable or traceable images, still or in motion or both;
one or more image capture devices;
a processor;
a computer;
and a distortion correction system in communication with said one or more image display devices, said one or more image capture devices, said processor, and said computer for converting one or more distorted image signals to one or more un-distorted images and providing one or more distortion free image signals to said one or more display image devices,
wherein the processor is configured to: interface with said one or more image display devices, said one or more image capture devices, and said distortion correction system; process one or more images captured; determine the geographic location of the said one or more image capture devices and said one or more image display devices; compile a set of location based coordinate updates; supply said distortion correction system with the location based coordinate updates; determine a characteristic associated with said one or more image capture devices and said one or more image display devices; and select the coordinate update to be supplied to said distortion correction system from the compiled set of location based coordinate updates.

2. The interactive education system of claim 1, further comprising: a student progress feedback system in communication with said one or more image display devices, said one or more image capture devices, said processor, and said computer to provide the student user with quantitative feedback as he or she constructs an art form displayed by the interactive education system of claim 1;
wherein the student progress feedback system is configured to: analyze and evaluate the geometrical structure of one or more pieces of artwork or portions thereof; establish benchmarked parameters of one or more pieces of artwork or portions thereof; compare two or more pieces of artwork or portions thereof, determine the authenticity or likeness of two or more pieces of artwork or portions thereof; and provide quantitative feedback to the student user based on the authenticity or likeness of an image.

3. The interactive education system of claim 1, further comprising: an image format distinguishing system for distinguishing between image formats, types, colors, physical or non-physical embodiments, reflections, or any other difference between images.

4. The interactive education system of claim 1, further comprising: one or more stands for holstering said one or more image display devices or said one or more capture image devices or one or more of both.

5. The interactive education system of claim 1, wherein said one or more image display devices are projectors which can be placed at any reasonable distance and any reasonable angle from the user's working surface to minimize the formation of a shadow due to the student user's hand, fingers, or body part that causes a shadow.

6. The interactive education system of claim 1, wherein one or more image display devices displays one or more images in one or more colors, one or more color shades, or any way to illustrate the path, speed, force, or other characteristics of a stroke.

7. The interactive education system of claim 1, further comprising a secondary distortion correction system for manually distorting one or more images.

8. A method of teaching and practicing art by providing a distortion-free video or static signal onto a user's workspace, the method comprising the steps of:
opening an electronic image file on a computer with, or without, gridlines or blank portions;
entering initial user information into the computer;
evaluating the image file and the initial user information to determine potential shadow formations from a user's hand, fingers, or body part that causes a shadow;
recommending a placement position for one or more image display devices and one or more image capture devices;
positioning one or more image display devices and one or more image capture devices;
establishing a computer connection with the one or more image display devices and the one or more image capture devices;
pre-distorting the electronic image file with default parameters;
displaying pre-distorted image;
capturing displayed pre-distorted image;
distorting captured images continually until the displayed image is distortion-free.

9. The method of claim 8, further comprising the step of: displaying gridlines onto a distortion-free image or onto a student's workspace or both;

10. The method of claim 8, further comprising the step of: and displaying one or more demonstrable or traceable images, still or in motion.

11. The method of claim 8, further comprising the step of: and displaying one or more demonstrable or traceable images, still or in motion, in one or more colors, one or more color shades, or any way to illustrate the path, speed, force, or other characteristics of a stroke.

12. The method of claim 8, further comprising the step of:
determining the visibility range of the image capture device due to the user's position and movements;
recommending placement of one or more secondary image capture devices that allows image capture of the artists entire work piece;
and providing the secondary image capture device in the recommended location.

13. The method of claim 8, further comprising the step of:
determining the likely shadow formation from the user's hand strokes based on the relative position of the image display device; and
recommending placement of one or more secondary image display devices to eliminate a potential shadow.

14. The method of claim 8, further comprising the steps of:
entering or collecting the length and width of the students working paper;
calculating the maximum size or sizes of the images to be displayed on the working paper;
selecting the image size or sizes to be displayed; and
displaying the selected image or images.

15. The method of claim 8, further comprising the steps of: demonstrating the sequences and/or speeds for one or more strokes required to construct an image.

16. A method of teaching and practicing art by providing a distortion-free video or static signal onto an artist's workspace while minimizing the formation of a shadow from the artist's hand or fingers, the method comprising the steps of:
providing an image display device;
providing at least one test pattern having a plurality of features disposed thereon;
providing an image capture device having a camera and an image processor;
capturing at least one calibration image of the test pattern using the camera;
analyzing the at least one calibration image using the image processor to provide a calibration data table;
storing the calibration data table in the image processor;
determining the location of the image display device relative to the artist's work piece and the image capture device;
determining the location of a shadow formation due to the artist's hand strokes and the relative position of the image display device;
recommending placement of one or more secondary image display devices to eliminate a potential shadow;
wherein: the step of analyzing the at least one calibration image using the image processor to provide a calibration data table includes the steps of storing known geometric features of the least one test pattern in the image processor, identifying portions of the calibration image that correspond to the features of the test pattern to provide calibration image feature position data, and analyzing the calibration image feature position data based on the known geometric features of the at least one test pattern to provide the calibration data table; the step of determining whether a shadow is likely to be formed includes the steps of determining the vertical and horizontal tilt angle of the image display device relative to the artist's work piece and analyzing the potential hand stokes of the certain artwork to be performed; and the step of recommending placement of one or more secondary image display devices includes the steps of analyzing the potential position of the shadow from the first image display device and determining a position for one or more secondary image display device to prevent the shadow formation.

17. The method of claim 16, further comprising the step of:
determining the range limitations of the image capture device on the user's work piece;
recommending placement of one or more secondary image capture devices that allows image capture of the user's entire work piece; and
providing one or more secondary image capture devices in the recommended location.

18. The method of claim 16, further comprising the steps of:
generating a raw video or static signal using the camera; and
correcting the raw video signal using the image processor based on the calibration data table for one or more image display device positions to provide a distortion-free video signal.

19. The method of claim 16, further comprising the steps of:
entering or collecting the length and width of the students working paper;
calculating the maximum size or sizes of the images to be displayed on the working paper;
selecting the image size or sizes to be displayed; and
displaying the selected image or images.

20. The method of claim 16, further comprising the steps of: demonstrating the sequences and/or speeds for one or more strokes required to construct an image.
